(19) United States
(12) Patent Application Publication
(10) Pub. No.: US 2017/0169738 A1
(43) Pub. Date: Jun. 15, 2017

(54) THERMAL INK LABELLED PACKAGING

(71) Applicant: International Business Machines Corporation, Armonk, NY (US)

(72) Inventors: Milnes P. David, Poughkeepsie, NY (US); William J. O. Green, Cary, NC (US); Joseph F. Prisco, Rochester, MN (US); Robert T. Sanders, Wilmington, NC (US); Sharon T. Spaulding, Highland, NY (US)

(21) Appl. No.: 14/966,283

(22) Filed: Dec. 11, 2015

(51) Int. Cl. G09F 3/00; G06Q 10/08; B41M 3/00; B41M 5/28; B41M 5/323

(52) U.S. Cl. CPC G09F 3/0294; B41M 5/281; B41M 5/323; B41M 3/001; G06Q 10/0832; B41M 2205/42; G09F 2003/0202

(57) ABSTRACT

Disclosed herein is a packaging label. The label includes a first region comprising a first thermochromic ink where the first thermochromic ink undergoes a permanent change from a first state to a second state when exposed to a first temperature. The label includes a second region having a second thermochromic ink where the second thermochromic ink undergoes a temporary change from the first state to the second state when exposed to the first temperature only to return to the first state upon being exposed to a desired second temperature.

### BACKGROUND

The embodiments described herein relate generally to labeling. More specifically, the embodiments described herein relate to thermal ink labeled packaging.

Temperature sensitive materials (hereinafter “goods”) are often mailed by suppliers to users using public postal mail or other private delivery services (e.g., UPS, Federal Express, DHL, and the like). The transportation of these goods often takes place across geographic areas with widely varying temperature conditions. As a result, the goods are often subjected to extreme weather conditions. One particularly undesirable set of extreme weather conditions are low temperatures where undesirable moisture condensation can occur on/in the goods or where phase changes (e.g., being transformed from liquids to solids) can occur. The occurrence of phenomena such as condensation or phase change can often render the goods non-functional or impair their functioning, especially if they are operated in their altered state. Often, the goods can be recovered if they are conditioned to remove the condensate or to undergo a phase change reversal prior to being deployed or used.

It is therefore desirable to have a system that enables a recipient of the goods to be aware of the conditions that the goods have been subjected to and whether they are in a condition to be used immediately upon receipt or whether they should be subjected to the proper conditioning prior to being deployed or used.

### SUMMARY

Disclosed herein is a packaging label comprising a first region comprising a first thermochromic ink, wherein the first thermochromic ink undergoes a permanent change from a first state to a second state when exposed to a first temperature; and a second region comprising a second thermochromic ink, wherein the second thermochromic ink undergoes a temporary change from the first state to the second state when exposed to the first temperature and returns to the first state upon being exposed to a desired second temperature.

Disclosed herein too is a method comprising disposing on a substrate a first thermochromic ink on a first region and a second thermochromic ink on a second region of the substrate, wherein the first thermochromic ink undergoes a permanent change from a first state to a second state when exposed to a first temperature, wherein the second thermochromic ink undergoes a temporary change from the first state to the second state when exposed to the first temperature and returns to the first state upon being exposed to a desired second temperature.

Disclosed herein too is a method comprising sending to a recipient a package containing a packaging label, wherein the packaging label comprises a first region comprising a first thermochromic ink, wherein the first thermochromic ink undergoes a permanent change from a first state to a second state when exposed to a first temperature; and a second region comprising a second thermochromic ink, wherein the second thermochromic ink undergoes a temporary change from the first state to the second state when exposed to the first temperature only to return to the first state upon being exposed to a desired second temperature; observing the packaging label to determine whether the packaging label has experienced the first temperature during a delivery; and conditioning the package until the packaging label indicates that a temperature of the package is at a second temperature, different from the first temperature.

### BRIEF DESCRIPTION OF THE FIGURES

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a depiction of a thermochromic label according to an embodiment;

FIG. 2 is a depiction of a thermochromic label according to an embodiment; and

FIG. 3 is a flow diagram that represents a use of a thermochromic label according to an embodiment.

### DETAILED DESCRIPTION

Disclosed herein is an article for notifying and forewarning a recipient (of shipped goods) of the conditions that the goods have been subjected to during transit and the condition that the goods are presently in relative to the condition that they should be in prior to being operated. The system comprises using a label on packaging that indicates to the recipient whether the goods have experienced adverse conditions that would affect performance and whether they are still under the influence of those conditions. In an embodiment, the label is a thermochromic label that undergoes a color change when subjected to environmental conditions that lie outside a prescribed range. In another embodiment, the label also provides directions to the recipient on the conditioning procedures to be followed when the goods have been subjected to undesirable conditions. In an embodiment, these conditioning procedures are detailed on the packaging only when the goods have been subjected to undesirable conditions and are still under the influence of the undesirable conditions. The recipient upon reading the label would then subject the goods to the requisite conditioning till the goods reach a stable condition where they can be used.

Embodiments disclose use of a label printed with thermochromic ink as a passive visual indicator of temperature for shipment and delivery to indicate conditions where harmful temperature conditions were experienced in transit, and to indicate when products are acclimated and ready for removal of protective packaging. The label comprises at least two regions—a first region that has a first ink that is thermochromic and that undergoes a permanent change (upon being subjected to undesirable conditions) and a second region that has a second ink that is thermochromic and that undergoes reversible changes (upon being subjected to undesirable conditions). The label may optionally contain more than two regions such as, for example, a third region that uses non-thermochromic inks. The label also therefore acts as a “go/no-go” gauge.

The first region of the label that comprises the permanent thermochromic ink (also termed the first thermochromic ink) undergoes a permanent change when the goods experience undesirable conditions enroute. In an embodiment, when the permanent thermochromic ink is deployed, the label may optionally display a first set of instructions as to how to proceed with unwrapping the goods and how to inspect them because of the undesirable conditions that they experienced enroute. The permanent change in the thermochromic ink therefore forewarns the recipient that the goods did indeed experience undesirable conditions enroute and that care should be taken to examine the goods and the packaging carefully prior to opening and using them. It is to be noted that for the permanent thermochromic ink, the permanent change is a change in color.

The second region of the label that comprises the temporary thermochromic ink (also termed the second thermochromic ink) undergoes a reversible change from a first state to a second state when the goods experience undesirable conditions. In other words, the temporary thermochromic ink continues to display a change to the second state when the goods are experiencing undesirable conditions. When the goods cease to experience undesirable conditions, the thermochromic ink reverses its change of state and reverts to its first state. In an exemplary embodiment, the change of state includes a change of color from a first color to a second color. The first color is different from the second color.

In an embodiment, when the temporary thermochromic ink is deployed, the label displays a second set of instructions as to how to proceed with conditioning the goods until they have reached the desired conditions at which they can be used. In one embodiment, the second set of instructions are temporary—i.e., they appear when the conditions are undesirable and they disappear from view when the desired conditions are reached. It is to be noted that the second thermochromic ink may therefore be invisible (in visible light) in its first state and visible only in its second state.

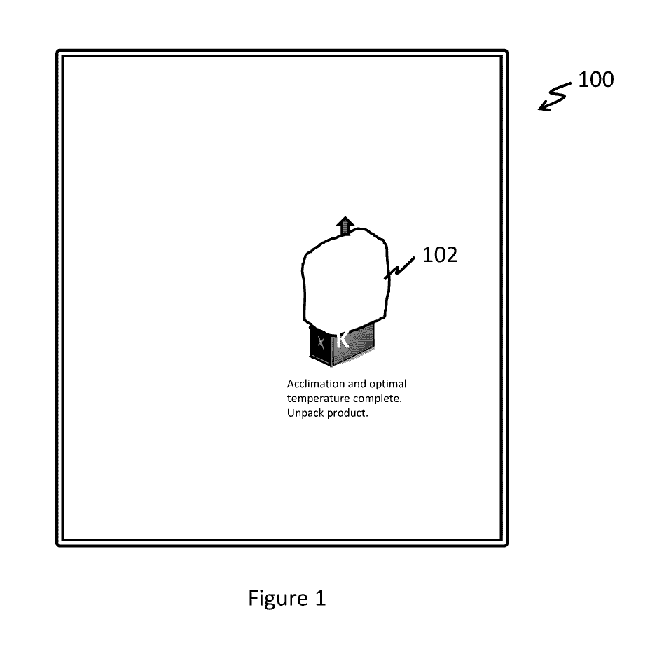

FIG. 1 is a depiction of a thermochromic label 100 for use on goods that may be subjected to a variety of environmental conditions during transit from one place to another. In this particular event the goods did not experience any adverse conditions. The label 100 therefore shows a product that has reached the recipient under the desirable conditions without ever having been subjected to undesirable conditions. Instructions 102 on the label notify the recipient that the product has been transported under the right conditions. The ink that provides the notification on the label is permanent thermochromic ink and indicates that the goods have experienced no undesirable conditions and are ready for installation and use.

It is to be noted that while the label in the FIG. 1 contains both the first region and the second region on a single label, they may be spaced apart from each other on a single package. In short, the first region and the second region may be disposed on a single label (as seen in the FIG. 1), or alternatively, they may be disposed on a single package but may not contact each other. In yet another embodiment, the first region and the second region may contact each other but are present on separate labels.

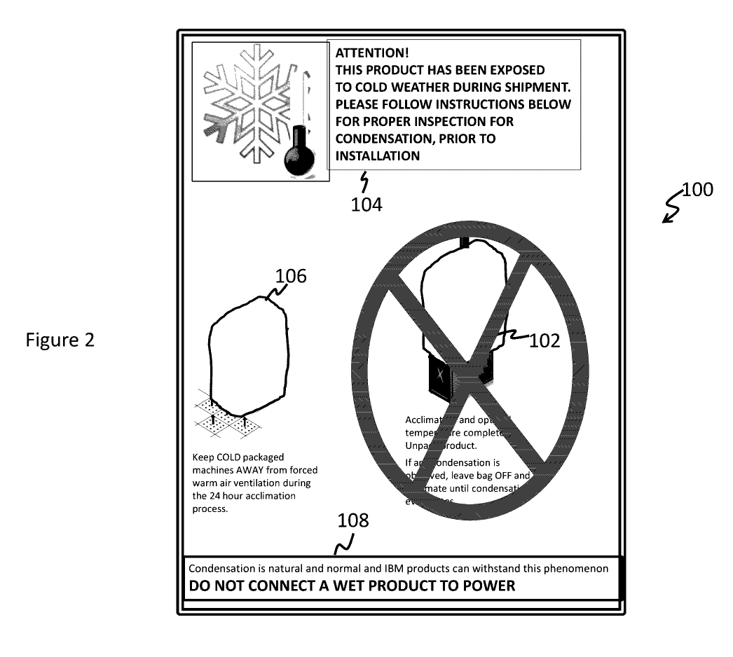

The FIG. 2 on the other hand is a depiction of a thermochromic label 100 where the goods have experienced undesirable conditions during transit from one place to another. The goods are still experiencing undesirable conditions. The instructions 102 that previously (See FIG. 1) indicated that the goods were acceptable for installment are now crossed-out with a big “X” sign. The “X” sign is in temporary thermochromic ink and represents a second state of the thermochromic ink that is contained in the sign. Instructions 104, 106 and 108 are exemplary instructions in permanent thermochromic ink provide the user with warnings not to use the goods till properly acclimatized and provide instructions on how to acclimatize the goods for proper use.

When the goods have reached the appropriate desired temperatures, the temporary ink (being reversible) returns to its first state and no longer appears visible on the label. Thus for example, upon returning to a desired temperature, the “X” sign on the label undergoes a reversion to its earlier invisible first state.

Since the label has the capability to display both permanent changes and others that display temporary changes, it generally contains two different thermochromic inks—one which is capable of undergoing a permanent change and the other being capable of undergoing a reversible change.

In an embodiment, it is desirable to use a thermochromic ink that has either a permanent or a reversible transition from the first state to the second state at −10° C. to 10° C., preferably −5° C. to 5° C. and more preferably −2° C. to 2° C.

Suitable thermochromic inks for use in the label are liquid crystals, leuco dyes, or a combination thereof. Liquid crystals are used in precision applications, as their responses can be engineered to accurate temperatures. Leuco dyes allow wider range of colors to be used, but their response temperatures are more difficult to set with accuracy.

Liquid crystals are used in applications where the temperature at which the color change occurs has to be accurately defined. Some liquid crystals are capable of displaying different colors at different temperatures. This change is dependent on selective reflection of certain wavelengths by the crystal structure of the material, as it changes between the low-temperature crystal phase, through anisotropic chiral or twisted nematic phase, to the high-temperature isotropic liquid phase. Only the nematic mesophase has thermochromic properties; this restricts the effective temperature range of the material.

The twisted nematic phase has the molecules oriented in layers with regularly changing orientation, which gives them periodic spacing. The light passing through the crystal undergoes Bragg diffraction in these layers and the wavelength with the greatest constructive interference is reflected back, which is perceived as a spectral color. A change in the crystal temperature can result in a change of spacing between the layers and therefore in the reflected wavelength. The color of the thermochromic liquid crystal can therefore continuously range from non-reflective (black) through the spectral colors to black again, depending on the temperature. Typically, the high temperature state will reflect blue-violet, while the low-temperature state will reflect red-orange. Since blue is a shorter wavelength than red, this indicates that the distance of layer spacing is reduced by heating through the liquid-crystal state.

Examples of liquid crystalline materials are cholesteryl nonanoate or cyanobiphenyls. Liquid crystals used in dyes and inks often come microencapsulated, in the form of suspension. Liquid crystals are preferred thermochromic inks for the temporary thermochromic inks that undergo a reversion in color.

Thermochromic dyes based on mixtures of leuco dyes with suitable other chemicals such as a base pigment, acids and a solvent may also be used in the labels. The leuco dyes display a color change (usually between the colorless leuco form and the colored form) with a change in temperature. Examples of leuco dyes are spirolactones, fluorans, spiropyrans, fulgides, or a combination thereof. They are usually used in combination with another pigment producing a color change between the color of the base pigment and the color of the pigment combined with the color of the non-leuco form of the leuco dye. Organic leuco dyes are available for use at temperatures of −5° C. (23° F.) to 60° C. (140° F.), in wide range of colors. The color change usually happens in a 3° C. (5.4° F.) interval. Leuco dyes can be microencapsulated. Microencapsulation allows for their use in labels as the thermochromic ink that undergoes permanent color change. The size of the microcapsules is 3 to 5 micrometers.

In addition to the use of the labels as a “Go/No-Go Gauge” instructions that the permanent and temporary thermochromic ink label provides, a printed QR® code (Quick Response Code, two dimensional barcode or any other image/brand, readable by image recognition software may also be provided with the label on the package. This will allow the recipient the ability to gain “real time” access (via a smartphone, tablet, or other mobile device) to a link with additional instructions or smartphone applications on how to and when to proceed with safely unpackaging and installing the product. This QR® code/link will appear only when the link to the instructions are appropriate. This combination of both printed instructions and internet accessible links, thus provide the recipient with the ability to proceed correctly (in the event that the goods have experienced undesirable conditions) by accessing a virtual library where answers to frequently asked questions may be found, a hotline number, and/or chat link for support.

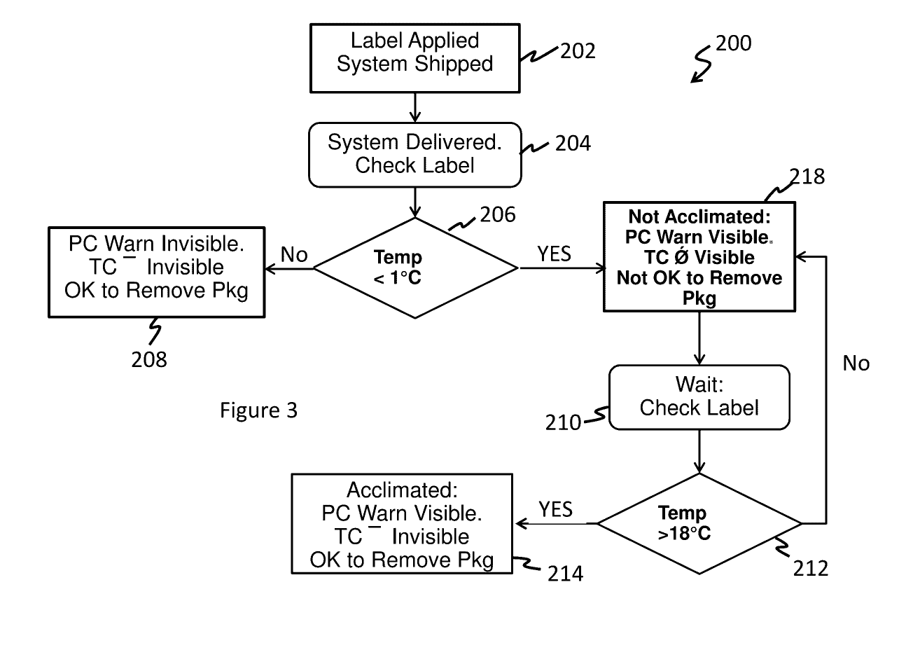

FIG. 3 is a flow diagram 200 that represents an exemplary manner of using the label disclosed herein. The package is shipped with the label 202 and is delivered to the recipient who checks the label 204. If the package has not experienced a temperature of less than 1° C. (206) in transit then the label (both the first region and the second region) will not show any permanent or temporary color change. The goods can be removed from the packaging and used (208).

If on the other hand, the package has experienced a temperature of less than 1° C. in transit, the warning on the label will show a permanent color change in the first region and a temporary color change in the second region (218) if and only if the goods are still below the desirable temperature. The goods are to be acclimatized (210) for a period of time to reach a desired temperature as determined by the installation environment. For instance for a data center operating within the ASHRAE (American Society of Heating, Refrigerating and Air-Conditioning Engineers) recommended operating envelope the desired temperature is 18° C. The goods are to be acclimatized (210) for a period of time to reach a desired temperature of 18° C. (212). This desired temperature and corresponding label can be tailored for different install environments providing more client specific guidance. When the goods reach the desired acclimatization temperature (214), the label shows a permanent change in the first region (indicating that the package did indeed experience undesirable temperature conditions) but the second region does not show any color change (since the thermochromic ink in the second region will have undergone a reversion from its second state to the first state). The goods can now be removed and installed for further use.

In an embodiment, in one method of manufacturing the label, a substrate is used to dispose the first thermochromic ink in a first region of the substrate and the second thermochromic ink in a second region of the substrate. The first region and the second region may be overlapped with each other, may be disposed adjacent to each other or may be disposed apart from each other. The substrate may comprise a sheet of metal, a ceramic or a polymer. In an embodiment, the substrate is fibrous and comprises paper. The first thermochromic ink and the second thermochromic ink may be disposed on the substrate in either a molten state or in a solution state. They may be disposed by methods that include spin casting, doctor blading, dip coating, spray painting, electrostatic spray painting, or a combination thereof. Lithography including the use of masks may preferably be utilized when the first region and the second region overlap with each other.

The label is advantageous in that it both informs as well as directs the recipients and carriers when and when not to remove packaging in order to become acclimatized to temperature and humidity. It indicates when unfavorable conditions have been experienced during shipment by the product (i.e. freezing temperatures for water-cooled products and the like). It also does not unnecessarily direct the recipient to spend additional time inspecting for conditions (such as condensation or phase changes) if the goods never experienced undesirable conditions. Since the label comprises thermochromic inks that are activated by external environmental conditions it does not use any power. It is an inexpensive solution that can be used all year round.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A packaging label comprising:
a first region comprising a first thermochromic ink, wherein the first thermochromic ink undergoes a permanent change from a first state to a second state when exposed to a first temperature; and
a second region comprising a second thermochromic ink, wherein the second thermochromic ink undergoes a temporary change from the first state to the second state when exposed to the first temperature and returns to the first state upon being exposed to a desired second temperature.

2. The packaging label of claim 1, where the first region and the second region are disposed on a single label.

3. The packaging label of claim 1, where the first region and the second region are disposed on separate labels that do not contact each other.

4. The packaging label of claim 1, where the first region and the second region are disposed on separate labels that do contact each other.

5. The packaging label of claim 1, where the first state represents a first color and where the second state represents a second color.

6. The packaging label of claim 5, where the first color is different from the second color.

7. The packaging label of claim 1, where the first thermochromic ink comprises a liquid crystalline material.

8. The packaging label of claim 1, where the second thermochromic ink comprises a leuco dye.

9. The packaging label of claim 1, where the second thermochromic ink is invisible to a recipient of the packaging label when it is in its first state.

10. The packaging label of claim 1, where the second region in its second state provides directions to a recipient on conditioning procedures to be followed.

11. The packaging label of claim 9, where the second thermochromic ink in its second state is visible to the recipient.

12. The packaging label of claim 9, where the second thermochromic ink in its second state is visible to the recipient.

13. The packaging label of claim 1, where the second region contains a quick response section that provides information for a recipient to contact a source of information for conditioning procedures for goods contained in packaging accompanying the packaging label.

14. An article comprising the packaging label of claim 1.

15. A method comprising:
disposing on a substrate a first thermochromic ink on a first region and a second thermochromic ink on a second region of the substrate,
wherein the first thermochromic ink undergoes a permanent change from a first state to a second state when exposed to a first temperature,
wherein the second thermochromic ink undergoes a temporary change from the first state to the second state when exposed to the first temperature and returns to the first state upon being exposed to a desired second temperature.

16. The method of claim 15, where the first region and the second region overlap with each other.

17. The method of claim 16, wherein disposing is accomplished via spin coating, dip coating, spray painting, doctor blading, electrostatic spray painting, or a combination thereof

18. A method comprising:
sending to a recipient a package containing a packaging label, wherein the packaging label comprises:
a first region comprising a first thermochromic ink, wherein the first thermochromic ink undergoes a permanent change from a first state to a second state when exposed to a first temperature; and
a second region comprising a second thermochromic ink, wherein the second thermochromic ink undergoes a temporary change from the first state to the second state when exposed to the first temperature only to return to the first state upon being exposed to a desired second temperature; and
observing the packaging label to determine whether the packaging label has experienced the first temperature during a delivery; and
conditioning the package until the packaging label indicates that a temperature of the package is at a second temperature, different from the first temperature.

19. The method of claim 18, further comprising observing the packaging label to determine whether the packaging label is still experiencing the first temperature.
